(19) United States
(12) Patent Application Publication
(10) Pub. No.: US 2004/0112303 A1
(43) Pub. Date: Jun. 17, 2004

(54) Subject-retention system and coupler

(76) Inventor: Reynolds E. Moulton III, New York, NY (US)

Correspondence Address: LAHIVE & COCKFIELD, LLP., 28 STATE STREET, BOSTON, MA, 02109, US

(21) Appl. No.: 10/676,363

(22) Filed: Sep. 30, 2003

Related U.S. Application Data
(63) Continuation-in-part of application No. 10/061,113, filed on Feb. 1, 2002, now Pat. No. 6,626,131.
(60) Provisional application No. 60/299,738, filed on Jun. 22, 2001.
(60) Provisional application No. 60/446,678, filed on Feb. 11, 2003.
(60) Provisional application No. 60/446,679, filed on Feb. 11, 2003.

(51) Int. Cl. A01K 27/00

(52) U.S. Cl. 119/795

(57) ABSTRACT

A coupler may be provided to rotatably connect an extension leash to a belt. An extension leash may also be provided to extend to a collar or harness on the subject. A subject-retention system may also be provided having both a coupler and an extension leash. By use of an optional elastic portion, the impact of shocks along the extension leash may be softened. In operation, a belt may be mounted about a waist of an operator. A sheath in the form of a loop receives the belt through the loop. A rotating connector has a base fixed to the sheath and a rotatable mount that is rotatably and permanently mounted relative to the base. An extension leash may be provided having a connector to connect to the rotatable mount and rotate relative to the sheath.

### REFERENCE TO RELATED APPLICATIONS

This application is a continuation-in-part of and claims the benefit of U.S. application Ser. No. 10/061,113, filed Feb. 1, 2002 and entitled Hand-Free Leash System, pending, which claimed priority to U.S. Provisional Application No. 60/299,738, filed Jun. 22, 2001 and entitled Leash. The present application also claims the benefit of U.S. Provisional Application No. 60/446,678, filed Feb. 11, 2003 and entitled Sheath With Swivel-Hook for Connecting Humans to Other Objects and U.S. Provisional Application No. 60/446,679, filed Feb. 11, 2003 and entitled Leash With Snap-Hook to Connect to Humans.

### TECHNICAL FIELD

The present invention relates to tethering of a subject to a human and more particularly to a coupler and subject-retention system to enable a rotatable connection between a belt mounted to an operator and an extension leash coupled to a subject.

### BACKGROUND

The tethering of a subject, such as a pet, to a human has typically required that the human operator hold on to a rope or strap in order to maintain control of the pet. For example, dog leashes are typically a rope having a hook on one end for attachment to a dog collar with a loop on an opposite end to be held by a person walking the dog. Such a dog leash is required to be held by the operator during use, and shocks provided by the dog lurching are transmitted through the strap to the arm of the operator. Oftentimes, this results in a yanking of the operator's arm, with uneven forces applied to a torso of the operator, potentially causing a loss of balance or overexertion of muscles in order to prevent the dog from getting away.

Such tugging or lurching may occur at any time while using a typical leash. Therefore, particularly with larger subjects such as large dogs, a user must remain vigilant and maintain a strong grip on the leash. This can often result in muscle fatigue and prevent a relaxing experience while walking a pet.

### SUMMARY

The present invention is adapted to be mounted about the waist of a human operator, thereby allowing for hands-free operation and distribution of forces from a subject to the operator.

The present invention provides apparatus for coupling a human operator to a subject. In particular, a coupler may be provided to rotatably connect an extension leash to a belt worn by the operator. An extension leash may also be provided to extend to a coupling device, such as a collar or harness, on the subject. Further embodiments of the invention provide for manual control of the extension leash by a loop and optional disconnection of a portion of the extension leash from the belt worn by the operator.

According to one embodiment, a coupler is provided for use with a belt for coupling an operator to a subject. The coupler includes a sheath in the form of a loop to receive the belt through the loop. A rotating connector has a base fixed to the sheath and a rotatable mount. The rotatable mount is rotatably and permanently mounted relative to the base. An extension leash may be coupled to the rotatable mount and rotate relative to the sheath.

Another embodiment of the invention provides a subject-retention system having a belt adapted to be mounted about a waist of an operator and a sheath in the form of a loop to receive the belt through the loop. A rotating connector has a base fixed to the sheath and a rotatable mount rotatably and permanently mounted relative to the base. An extension leash has a connector adapted to connect to the rotatable mount and rotate relative to the sheath.

An extension leash is provided in a further embodiment of the invention. The extension leash includes a strap and a first connector mounted to a first end of the strap. A second connector is mounted proximate to the first end of the strap and located to detach the first end of the strap from a second end of the strap. A third connector mounted to the second end of strap. An elastic portion to inhibit the transmission of shocks is located between the first end of the strap and the second end of the strap.

### BRIEF DESCRIPTION OF THE DRAWINGS

The invention will be apparent from the description herein and the accompanying drawings, in which like reference characters refer to the same parts throughout the different views.

FIG. 1 is an illustration of a subject-retention system according to an embodiment of the invention;

FIG. 2 is an illustration of a belt and coupler according to an example of an embodiment of the invention;

FIG. 3 illustrates coupler having a sheath that may be opened;

FIGS. 4A, 4B, 5A, 5B, 6A and 6B illustrate various examples of couplers according to examples of embodiments of the invention; and

FIGS. 7 and 8 illustrate examples of extension leashes according to embodiments of the invention.

### DETAILED DESCRIPTION

The present invention can enable coupling a human operator to a subject. In one implementation, a coupler is provided to rotatably connect an extension leash to a belt. An extension leash may also be provided to extend to a coupling device, such as a collar or harness, on the subject. A subject-retention system may also be provided having both a coupler and an extension leash.

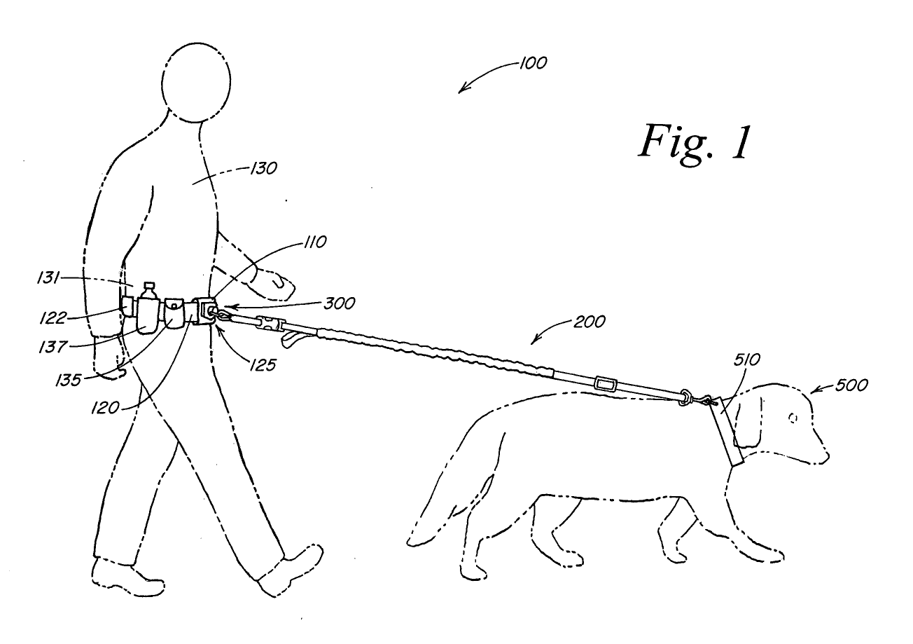

As illustrated in FIG. 1, a subject-retention system 100 is illustrated by way of example according to an embodiment of the invention. According to the illustrative embodiment of the invention, a coupler 125 includes a sheath 110 that is provided in the form of a loop to extend around a belt 120 that may be worn by an operator 130. The coupler 125 may also include a rotating connector 300 that is securely mounted to the sheath 110. An extension leash 200 can be coupled to the rotating connector 300 to extend to a subject 500. The extension leash 200 will typically be coupled to the subject 500 by the use of a coupling device 510, such as a collar or a harness, depending on the type of subject. The invention is applicable for use with a wide variety of subjects 500, such as, but not limited to, a pet or other animal, a child or other human.

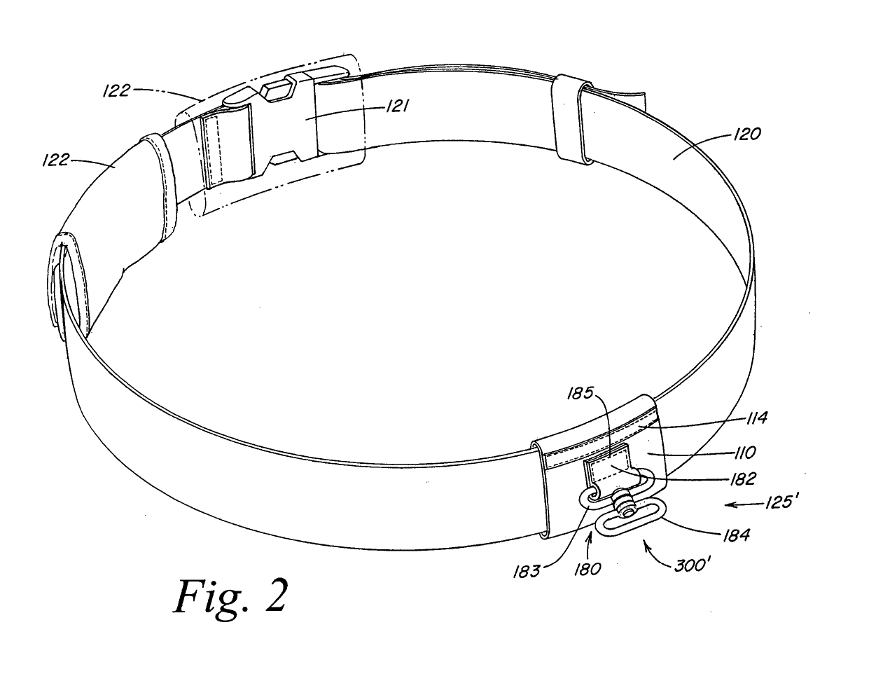

In operation, the subject-retention system 100 may be used by an operator to tether the subject 500 to the operator 130. Although a variety of configurations for mounting the belt 120 and coupler 125 to the operator 130 are within the scope of the invention, in one implementation, the operator secures a buckle 121 on the belt 120 before rotating the belt 120 about the operator's waist so as to position the buckle of the belt 120 along the back 131 of the operator. See FIGS. 1 and 2. Optionally, a pad 122 may be fitted over the buckle 121 to cushion the buckle 121 against the operator 130. The pad 122 may be formed in a closed loop or may be made as a loop that can be opened and closed. The loop may be held closed by the use of a fastener 112, examples include, but are not limited to, a hook and loop fastener, such as a VELCRO® fastener, available from Velcro USA of Manchester, N.H., a snap, a button, a zipper or other fastener suited for holding the ends of the material forming the loop together. The pad 122 may also not form a loop and could be affixed to a side of the belt 120 or attached to the belt 120 by the use of hooks extending over edges of the belt 120. The sheath 110 may be located at a position along the belt 120 in front of the operator, although the sheath 110 may optionally be moved along the belt 120 and located at another position.

The belt 120 may be a wide variety of belt types. For example, an elastic or a non-elastic belt, or a belt having a combination of elastic and non-elastic sections may be used. The use of a common belt, such as a leather belt used with trousers, is within the scope of the invention. Additional accessories, such as a pouch 135 and/or a bottle holder 137 may also optionally be mounted on the belt 120, as shown by way of example in FIG. 1.

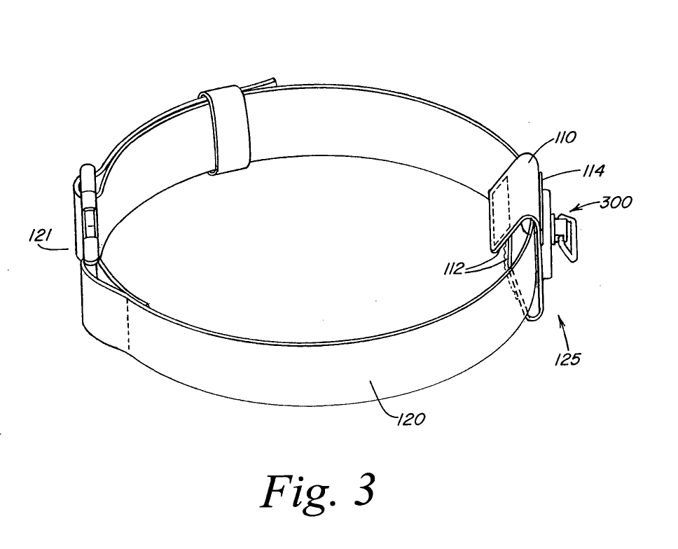

The sheath 110 may be formed of a wide variety of materials. In one implementation, a webbing, such as for example, a seat-belt-type webbing, is stitched to form a permanently closed loop. In another implementation, as illustrated by way of example in FIG. 3, the sheath 110 may be made as a loop that can be opened and closed. The loop may be held closed by the use of a fastener 112, examples include, but are not limited to, a hook and loop fastener, such as a VELCRO® fastener, available from Velcro USA of Manchester, N.H., a snap, a button, a zipper or other fastener suited for holding the ends of the material forming the loop together. In one implementation of the invention, a high visibility indicator 114 may also be provided on the sheath 110, the pouch 135, the bottle holder 137 and/or the pad 122. The high visibility indicator 114 may be formed of a reflective surface and fastened to or within the sheath 110. The sheath 110 may be positioned to allow the high visibility indicator 114 to be viewed by others, such as oncoming traffic.

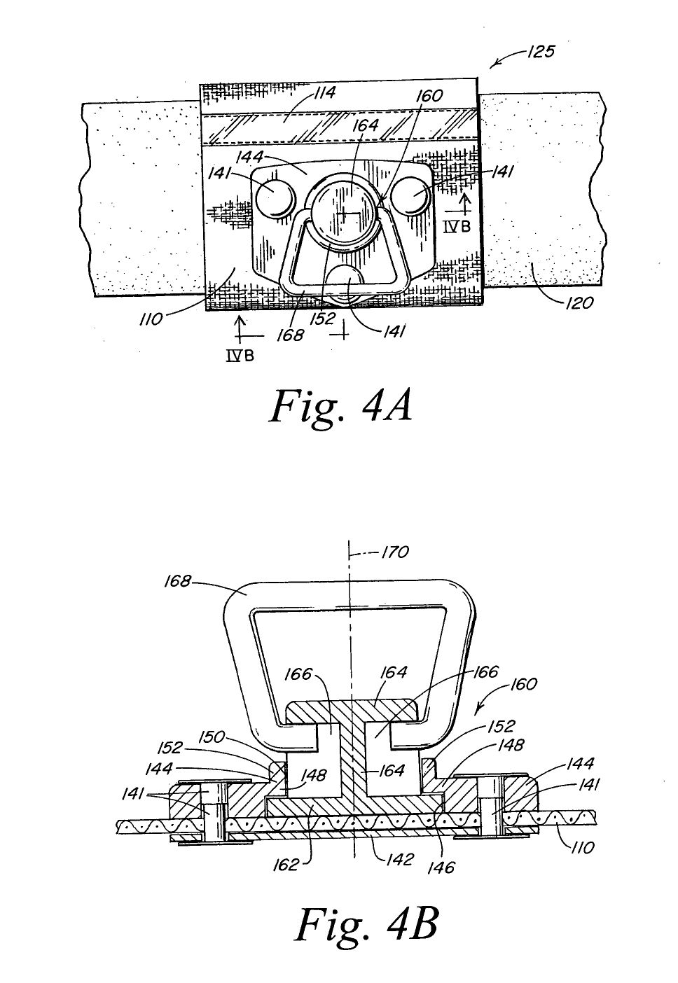

The coupler 125 provides a rotating connector 300 mounted to the sheath 110. Various examples of couplers 125 are illustrated in FIGS. 1 through 6B. With reference to FIGS. 4A through 6B, one or more rivets 141 may be used to mount the rotating connector 300 to the sheath 110. Optionally, a backing plate 142 may be provided on an opposite side of the sheath 110. The use of the backing plate 142 can provide additional strength and inhibit the rivets 141 from tearing out from the sheath 110.

The rotating connector 300 can include a base 144 fixed to the sheath 110 and a rotatable mount 160 which is rotatable relative to the base 144 and also therefore rotatable relative to the sheath 110. As shown in FIG. 4B, the base 144 may be formed with a recess 146 in which the rotatable mount 160 may be received. The recess 146 may be provided with a flange 148 and a reduced diameter portion 150. A protruding portion 152 may also be provided on the base 144 proximate to the reduced diameter portion 150.

According to an illustrative embodiment of the invention, the rotatable mount 160 has a circular portion 162 sized to rotate within the recess 146. A shaft portion 164 extends from the circular portion 162 and is sized to rotate within the reduced diameter portion 150. The shaft portion 164 is long enough to extend through the reduced diameter portion 150 and above the protruding portion 152.

According to the illustrative embodiment, the shaft portion 164 may be provided with receiving portions 166 located above the protruding portion 152 when the circular portion 162 is in the recess 146. An attachment device 168 may be mounted to the shaft portion 164, such as by extending into the receiving portions 166. In the example of FIG. 4B, the receiving portions 166 are large. The movement of the attachment device 168 may be controlled in part by the base 144, such as the protruding portion 152 of the base.

For purposes of illustration, an axis 170 along the shaft portion 164 is illustrated in FIG. 4B. In operation, the rotatable mount 160 may rotate about the axis 170. The attachment device 168 may be configured to rotate relative to the shaft portion 164 about an axis perpendicular to the axis 170. The attachment device 168 may also rotate with the shaft portion 164 about the axis 170. In some implementations, the attachment device 168 may rotate about the axis 170 independently of rotation of the shaft portion 164. The attachment device 168 and/or receiving portions 166 may be configured to limit the rotation of the attachment device 168 perpendicular to the axis 170, although this is merely an option. The protruding portion 152 can minimize contact of the attachment device 168 with portions of an upper surface 145 of the base 144.

Locating the attachment device 168 into the receiving portions 166 can prevent removal of the rotatable mount 160 from the base 144, as the attachment device 168 would contact the protruding portion 152. Movement of the rotatable mount 160 can also be minimized by the use of the optional backing plate 142. The backing plate 142 can provide a more rigidly-defined lower boundary of the recess 146, minimizing movement of the circular portion 162 and shaft portion 164 along the axis 170.

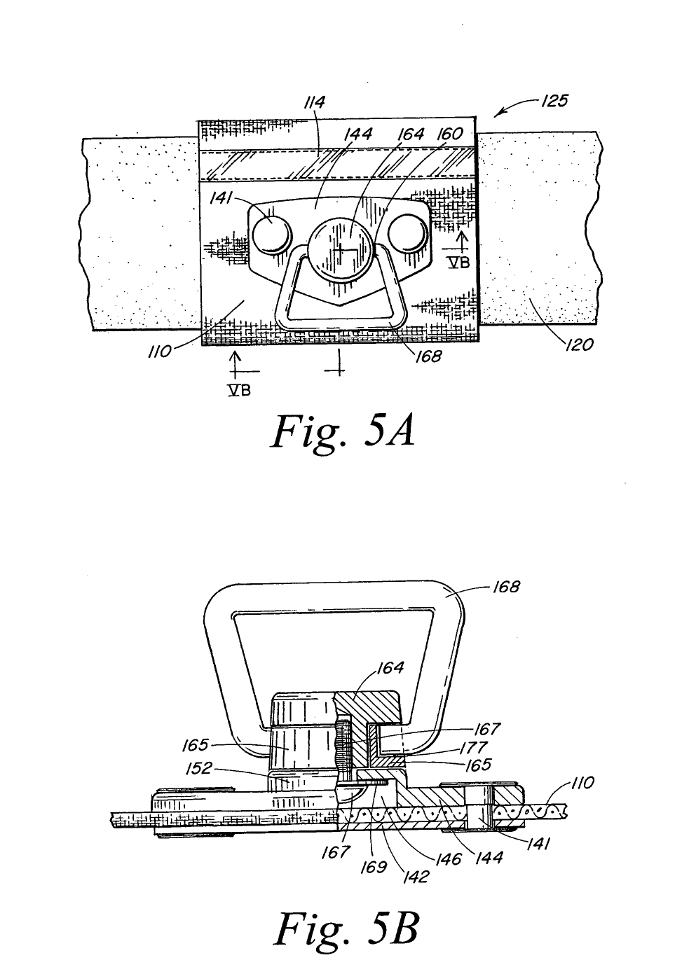

With reference to FIGS. 5A and 5B, another example of a coupler 125 is illustrated. A retention disk 165 may be positioned about the shaft portion 164. The retention disk may be provided with one or more cavities 177 in which to receive a portion of the attachment device 168. The retention disk may be configured to freely rotate about the shaft portion 164. The attachment device 168 may also rotate within the cavities 177 relative to the shaft portion 164. In the illustrated example of FIG. 5B, a circular portion of the rotatable mount 160, such as is shown in FIG. 4B, is omitted, as a bolt 167 is threaded from the recess 146, through the base 144 and into a portion of the shaft portion 164 to secure the shaft portion 164 to the base 144. A washer 169 may also be provided to distribute the force of the tightened bolt 167 on the flange 148 of the base 144.

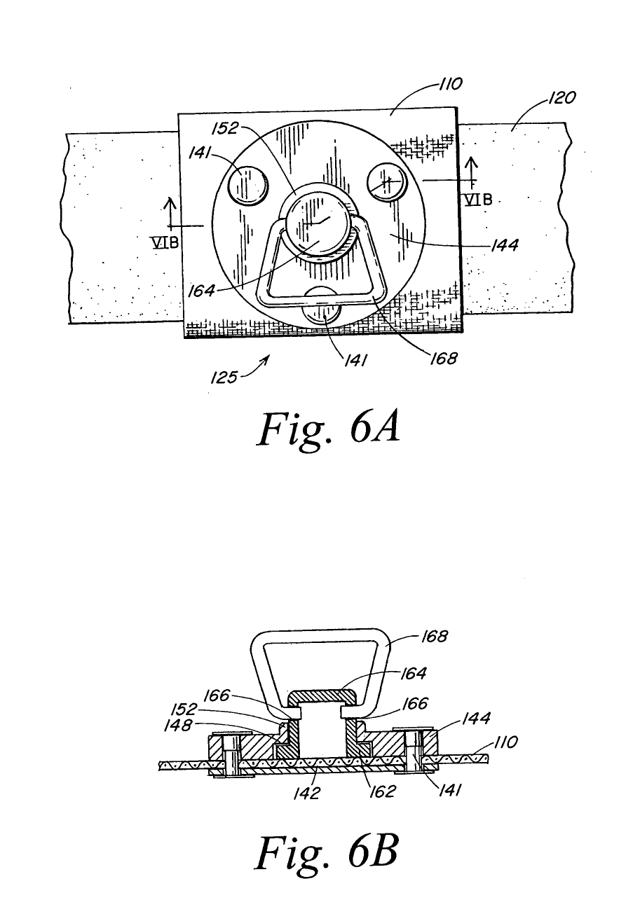

FIGS. 6A and 6B illustrate another example of a coupler 125 having a rotating connector similar to the example of FIGS. 4A and 4B. The shaft portion 164 illustrated in FIGS. 6A and 6B has smaller receiving portions 166 to control the location of the attachment device 168. In the example of FIG. 6B, the receiving portions 166 are smaller than those of the example of FIG. 4B. In the example of FIG. 6B, the receiving portions 166 may inhibit movement of the attachment device 168, such as inhibiting contact of the protruding portion 152 of the base.

A further example of a coupler 125′ with a rotating connector is illustrated in FIG. 2. According to this example, the rotating connector 300′ is formed by placing first portion 183 of a swivel hook 180 within a retaining portion 182 to form a base. The retaining portion 182 is fixedly secured to the sheath 110, such as by the use of rivets or stitching 185. According to this implementation, a rotatable mount is formed by a second portion 184 of the swivel hook 180 not located within the retaining portion 182. The swivel hook 180 enables rotation of the second portion 184 relative to the sheath 110.

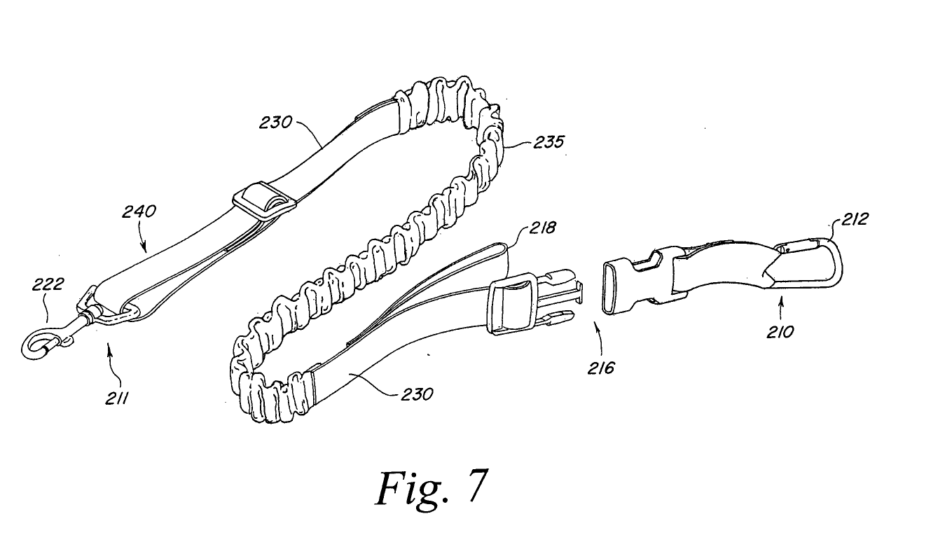

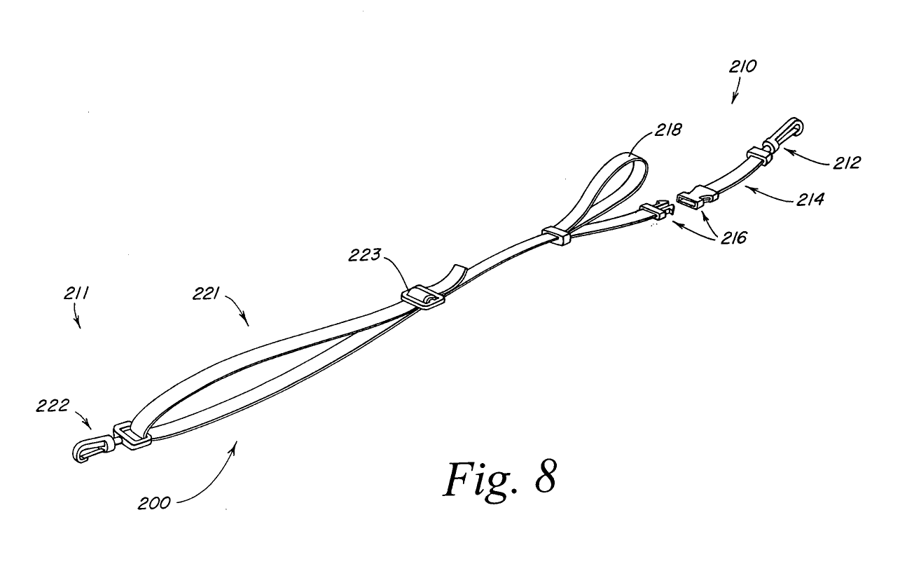

An extension leash 200 is illustrated by way of example in FIG. 6. According to the illustrative embodiment, the extension leash 200 is provided with a connector 212 such as a snap hook, carabineer or other similar device, at a first end 210 of a strap 230. A connector 222 is provided at a second end 211 of the strap 230 to enable the extension leash 200 to be coupled to a coupling device 510 mounted to a subject. The strap 230 may be formed of a wide variety of materials, both elastic and/or non-elastic and may include more than one type of material and a plurality of sections. For example, sections may be formed of nylon, polypropylene or other material, including those commonly used in strap and webbing applications. In the example illustrated in FIG. 7, a section is illustrated as an elastic portion 235. The elastic portion may inhibit the transmission of shocks between the first end 210 of the strap and the second end 211 of the strap 230. A length adjustment 240, such as an adjustable loop, may be provided to adjust the length of the extension leash 200. A connector 216, such as a side squeeze buckle, is provided proximate to the first end 210 so as to be within reach of an operator to detach the first end 210 of the strap 230 from the second end 211 of the strap 230. FIG. 8 illustrates another example of an extension leash 200 omitting an elastic portion.

The operator may optionally choose to control the subject 500 by the use of hand control. A manual loop 218 may be provided on the strap 230 beyond the connector 216 proximate to the first end 210, so as to enable an operator to operate the extension leash 200 by hand. The operator may optionally decide to detach the entire extension leash 200 at the snap hook 212, or may elect to detach the connector 216 of the extension leash 200, while leaving the snap hook 212 of the first end 210 of the extension leash 200 coupled to the attachment device 168 of the rotating connector 300. In such a case, the handle 218 operates in conjunction with the second end 211 of the extension leash 200, which remains coupled to the coupling device 510 and therefore the subject 500. Optionally, the operator may leave the connector 216 coupled and the first end 210 coupled to the rotating connector 300 and operate the handle 218 for greater control over the subject 500.

The present invention has been described by way of example, and modifications and variations of the exemplary embodiments will suggest themselves to skilled artisans in this field without departing from the spirit of the invention. The examples included herein are meant to be illustrative and not limiting. Features and characteristics of the above-described embodiments may be used in combination. The preferred embodiments are merely illustrative and should not be considered restrictive in any way. The scope of the invention is to be measured by the appended claims, rather than the preceding description, and all variations and equivalents that fall within the range of the claims are intended to be embraced therein.

Having described the invention, what is claimed as new and protected by Letters Patent is:

What is claimed is:

1. A coupler for use with a belt for coupling an operator to a subject, comprising:
a sheath in the form of a loop to receive the belt through the loop; and
a rotating connector having a base fixed to the sheath and a rotatable mount rotatably and permanently mounted relative to the base;
wherein an extension leash may be coupled to the rotatable mount and rotate relative to the sheath.

2. The coupler of claim 1, wherein the sheath is adapted to slide along the belt.

3. The coupler of claim 1, wherein the rotatable mount comprises:
a shaft, a portion of which is located within the base; and
an attachment device mounted to the shaft.

4. The coupler of claim 3, wherein the attachment device prevents removal of the shaft from the base.

5. The coupler of claim 3, wherein the shaft rotates relative to the base about a first axis and the attachment device rotates relative to the shaft.

6. The coupler of claim 5, wherein the attachment device rotates relative to the shaft about a second axis, perpendicular to the first axis.

7. The coupler of claim 3, wherein the attachment device further comprises a retention disk positioned about the shaft and proximate to the attachment device.

8. The coupler of claim 3, wherein the attachment device is rotatably mounted to the shaft.

9. A subject-retention system, comprising:
a belt adapted to be mounted about a waist of an operator;
a sheath in the form of a loop to receive the belt through the loop; and
a rotating connector having a base fixed to the sheath and a rotatable mount rotatably and permanently mounted relative to the base;
an extension leash, having a connector adapted to connect to the rotatable mount and rotate relative to the sheath.

10. The subject-retention system of claim 9, wherein the sheath is in the form of an openable loop.

11. The subject-retention system of claim 10, further comprising a hook and loop fastener configured to allow the loop to be opened and closed.

12. The subject-retention system of claim 9, wherein the sheath is in the form of a permanently closed loop.

13. The subject-retention system of claim 9, wherein the sheath is configured to slide along the belt.

14. The subject-retention system of claim 9, further comprising a quick release connector located along the extension leash to enable a first portion of the extension leash to remain coupled to the belt and a second portion of the extension leash to be detached from the belt.

15. The subject-retention system of claim 14, further comprising a manual loop mounted to the second portion of the extension leash.

16. The subject-retention system of claim 9, further comprising an elastic portion located along the extension leash.

17. The subject-retention system of claim 9, wherein the rotatable mount comprises:
a shaft, a portion of which is located within the base; and
an attachment device mounted to the shaft.

18. The subject-retention system of claim 17, wherein the attachment device prevents removal of the shaft from the base.

19. The subject-retention system of claim 17, wherein the attachment device is rotatably mounted to the shaft.

20. An extension leash, comprising:
a strap;
a first connector mounted to a first end of the strap;
a second connector mounted proximate to the first end of the strap and located to detach the first end of the strap from a second end of the strap;
a third connector mounted to the second end of strap; and
an elastic portion to inhibit the transmission of shocks between the first end of the strap and the second end of the strap.

21. The extension leash of claim 20, further comprising a manual loop mounted to the strap to detach from the first end of the strap and remain coupled to the second end of the strap upon release of the second connector.
